(19) United States
(12) Patent Application Publication
(10) Pub. No.: US 2018/0317396 A1
(43) Pub. Date: Nov. 8, 2018

(54) BATTERY POWERED HANDHELD OUTDOOR POWER EQUIPMENT

(71) Applicant: Briggs & Stratton Corporation, Wauwatosa, WI (US)

(72) Inventors: Patrick H. Bukowski, Waukesha, WI (US); Jeremiah John Guinta, West Allis, WI (US); Thomas Dean Morrell, Port Washington, WI (US); Stephen J. Ryczek, Hartland, WI (US)

(73) Assignee: Briggs & Stratton Corporation, Wauwatosa, WI (US)

(21) Appl. No.: 15/972,080

(22) Filed: May 4, 2018

Related U.S. Application Data
(60) Provisional application No. 62/502,044, filed on May 5, 2017.

(51) Int. Cl. A01G 3/06; B25F 5/00; A01D 34/84; A01D 69/02; A01D 43/16; A01D 34/68; A01D 34/78

(52) U.S. Cl. CPC A01G 3/062; B25F 5/001; A01D 34/84; A01D 2101/00; A01D 43/16; A01D 34/68; A01D 34/78; A01D 69/02

(57) ABSTRACT

A handheld edger includes an electric powerhead coupled to a mounting location, a member, and a cutting assembly. The electric powerhead includes a motor having an output shaft rotating at a first speed about an output shaft axis and a battery configured to power the motor. The member extends from the mounting location and includes an upper portion and a lower portion, the lower portion configured to be removable and replaceable to exchange one or more attachments. The cutting assembly coupled to the member includes a drive shaft, a blade coupled to and driven by the drive shaft, and a worm drive coupled to the output shaft of the motor and the drive shaft, the worm drive configured to cause the drive shaft to rotate the blade at a second speed. A gear ratio of the worm drive is larger than 40:1.

### CROSS-REFERENCE TO RELATED PATENT APPLICATIONS

This application claims the benefit of U.S. Provisional Application No. 62/502,044, filed May 5, 2017, which is incorporated herein by reference in its entirety.

### BACKGROUND

The present disclosure relates to the field of battery powered handheld outdoor power equipment, specifically lawn and garden handheld power equipment. In particular, the present disclosure relates to an electrically powered edger.

Handheld outdoor power equipment is typically powered by an internal combustion engine. This has been the accepted way to provide an operator with handheld equipment mobility, durability and performance consistency. Examples of such engine powered handheld outdoor power equipment are hedgers, string trimmers, chainsaws, edgers, cultivators, etc. More recently, handheld outdoor power equipment is being powered electrically. However, some electrically powered handheld applications, such as an edger, do not perform acceptably for customers. An electric motor in an edger may shut down when an overload is sensed causing the user to go through the repetitive steps of letting go of a trigger, pushing a safety button and starting the edger again, every time the motor shuts down. One of the only existing solutions to overcome this problem in a conventional edger is using a more powerful electric motor.

### SUMMARY

One embodiment of the herein described technology relates to a handheld edger. The handheld edger includes an electric powerhead coupled to a mounting location, a member, and a cutting assembly. The electric powerhead includes a motor having an output shaft rotating at a first speed about an output shaft axis and a battery configured to power the motor. The member extends from the mounting location and includes an upper portion and a lower portion, the lower portion configured to be removable and replaceable to exchange one or more attachments. The cutting assembly coupled to the member includes a drive shaft, a blade coupled to and driven by the drive shaft, and a worm drive coupled to the output shaft of the motor and the drive shaft, the worm drive configured to cause the drive shaft to rotate the blade at a second speed. A gear ratio of the worm drive is larger than 40:1.

Another embodiment of the herein described technology relates to a cutting assembly. The cutting assembly includes a drive shaft, a blade coupled to and driven by the drive shaft, and a worm drive coupled to an output shaft of a motor and the drive shaft, the worm drive configured to cause the drive shaft to rotate the blade at a second speed. A gear ratio of the worm drive is larger than 40:1.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, in which:

FIG. 1 is a front perspective view of a battery powered edger according to an exemplary embodiment;

FIG. 2 is a front perspective view of a portion of the battery powered edger of FIG. 1;

FIG. 3 is a side front side perspective view of a portion of the edger of FIG. 1;

FIG. 4 is a side view of an electric powerhead and battery with the battery removed from a battery receptacle of the edger of FIG. 1;

FIG. 5 is a side view of the electric powerhead with the battery inserted in the battery receptacle of the edger of FIG. 1;

FIG. 6 is a side perspective view of a portion of the edger of FIG. 1;

FIG. 7 is a side view of a cutting assembly of the edger of FIG. 1;

FIG. 8 is a front side perspective view of the cutting assembly of FIG. 7;

FIG. 9 is a front view of the cutting assembly of FIG. 7;

FIG. 10 is a front perspective view of the cutting assembly with a blade removed of FIG. 7;

FIG. 11A is a front perspective view of a cutting assembly of a cultivator;

FIG. 11B is a side view of the cutting assembly of FIG. 11A;

FIG. 11C is a side view of the cutting assembly of FIG. 11A with a fastener partially removed;

FIG. 11D is a side view of the cutting assembly of FIG. 11A with a blade removed;

FIG. 11E is a side view of the cutting assembly of FIG. 11A with two blades removed;

FIG. 11F is a side view of a wheel;

FIG. 11G is a side view of a blade used with the edger of FIG. 1;

FIG. 11H is a side view of the cutting assembly of FIG. 11A with the wheel of FIG. 11F inserted onto a drive shaft;

FIG. 11I is a side view of the cutting assembly of FIG. 11A with the wheel of FIG. 11F and the blade of FIG. 11G inserted onto a drive shaft;

FIG. 11J is a front perspective view of the cutting assembly of FIG. 11A with the wheel of FIG. 11F and the blade of FIG. 11G inserted onto a drive shaft;

FIG. 11K is a side view of a wheel with a rod;

FIG. 11L is a side view of the cutting assembly of FIG. 7 with the wheel and rod of FIG. 11J; and

FIG. 11M is a front perspective view of the cutting assembly of FIG. 7 with the wheel and rod of FIG. 11J and the wheel of FIG. 11F and the blade of FIG. 11G inserted onto a drive shaft.

### DETAILED DESCRIPTION

Before turning to the figures, which illustrate the embodiments in detail, it should be understood that the present application is not limited to the details or methodology set forth in the description or illustrated in the figures. It should also be understood that the terminology is for the purpose of description only and should not be regarded as limiting.

Referring generally to the figures, in one embodiment, an edger being powered by a removable, rechargeable battery is provided. The edger includes a housing positioned near the top of the unit and an edging assembly positioned near the bottom. The housing includes a battery receptacle to receive a removable, rechargeable battery. The edging assembly has one rotating blade forming a trench in the ground and cutting grass in its cutting path. The edger described herein allows a user to complete an edging task with a reduced potential for encountering an overload condition due to the worm drive gear ratio, blade and tine design, and wheel arrangement. In this way, an operator can complete an edging task without interruption to the motor. The relatively large reduction in gear ratio of the worm drive described herein allows the blade to turn relatively slow and reduces the likelihood of an overload detection by the motor. The blade described herein also facilitates the prevention of shutdowns due to overload by using a flat tine design. In addition, the two guide wheels described herein also help to facilitate proper performance of the edger 100. Other types of tasks including cutting, tilling, digging, etc., may also be improved in this way.

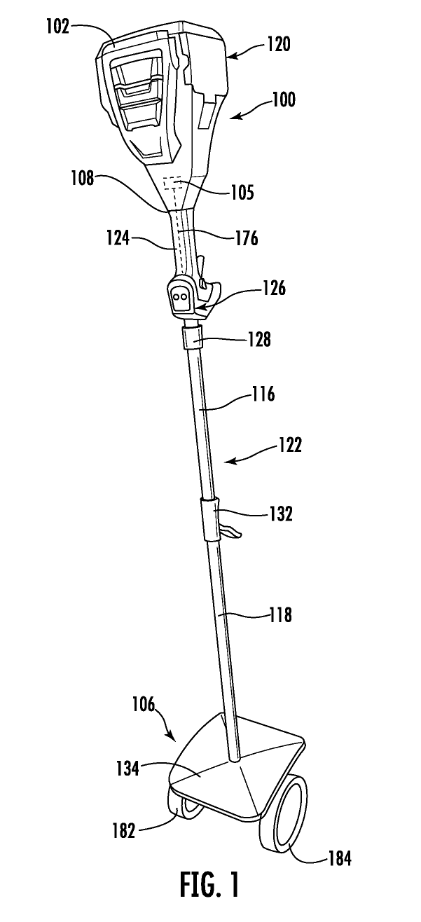

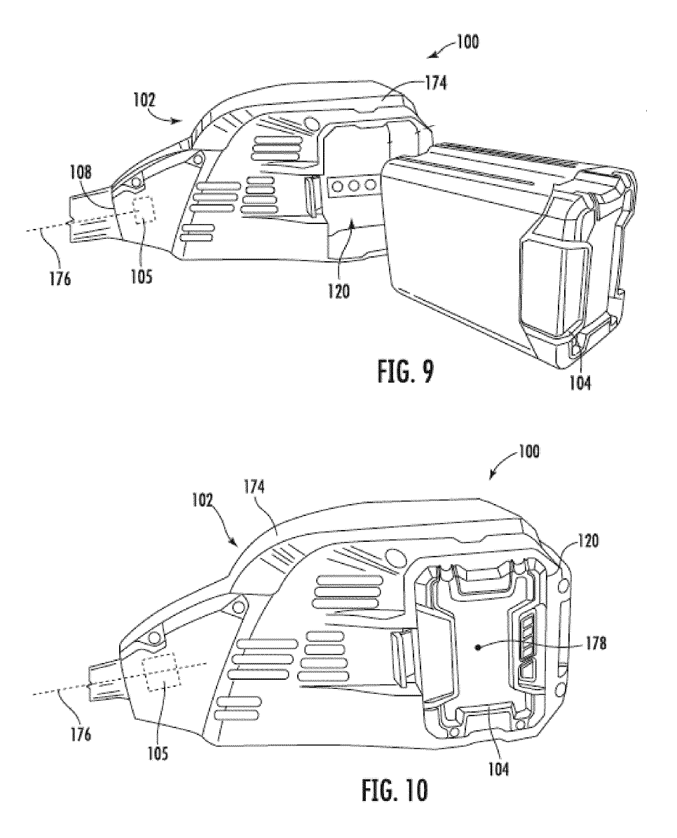

Referring to FIG. 1, a handheld battery powered edger 100 is shown according to one embodiment. The edger 100 includes an electric powerhead 102 having an electric motor 105, an energy storage device or battery 104 (FIG. 9) that powers the electric motor 105 and other electrical components and a cutting assembly 106. The electric powerhead 102 serves as a replacement for a small internal combustion engine of the type frequently used on a variety of portable power equipment, e.g., an edger. In one exemplary embodiment, the electric motor is an 800 watt electric motor, and the battery is an 82 Volt, 2-4 amp-hour battery. Other power levels, voltages, battery capacities, are contemplated. For example, the battery voltage could range from 12V to voltages greater than 82V; the battery capacity could be more or less than 2-4 amp-hours; the motor power could be more or less than 800 watts.

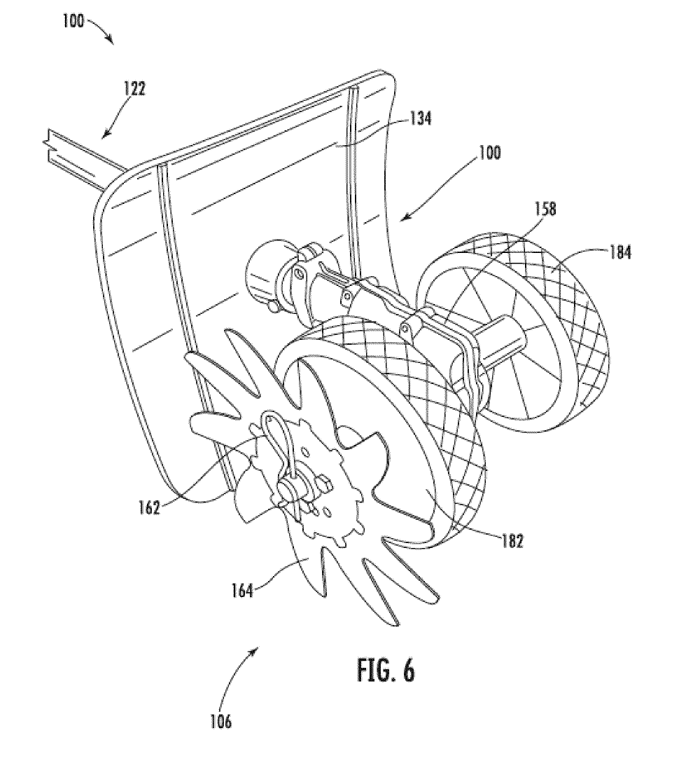

Referring to FIG. 1, the electric powerhead 102 is attached to a mounting location 108. The battery 104 (FIG. 9) is removable from a battery receptacle 120. The battery 104 provides electrical energy for use by the electric powerhead 102 and any external electrical components connected to the electric powerhead 102 when the battery 104 is properly inserted into the battery receptacle 120. A tubular frame 122 extends from the mounting location 108 that includes a gripping portion 124, a user interface 126, a first bracket 128, a handle 130 (FIG. 6), a second bracket 132 and a shield 134 extending from or affixed to the tubular frame 122. The gripping portion 124 provides a user a portion of the edger 100 for grasping with a hand to direct the direction of travel of the edger 100. The gripping portion 124 may be a soft, flexible material that provides the user with comfort while grasping the edger 100 during operative and inoperative periods.

Referring to FIG. 1, the tubular frame 122 further includes an upper portion 116 and a lower portion 118. The upper portion 116 may be removable from the lower portion 118. The upper portion 116 extends from the mounting location 108 and is configured to receive the lower portion 118 of a variety of outdoor portable power attachments, e.g., trimmer, hedger, etc. In the exemplary embodiment, the lower portion 118 may be removed from the upper portion 116 by loosening a fastening device (not shown) on the second bracket 132. The user is able to use the same electric powerhead 102 to perform a variety of tasks by attaching the various attachments to complete job-specific tasks.

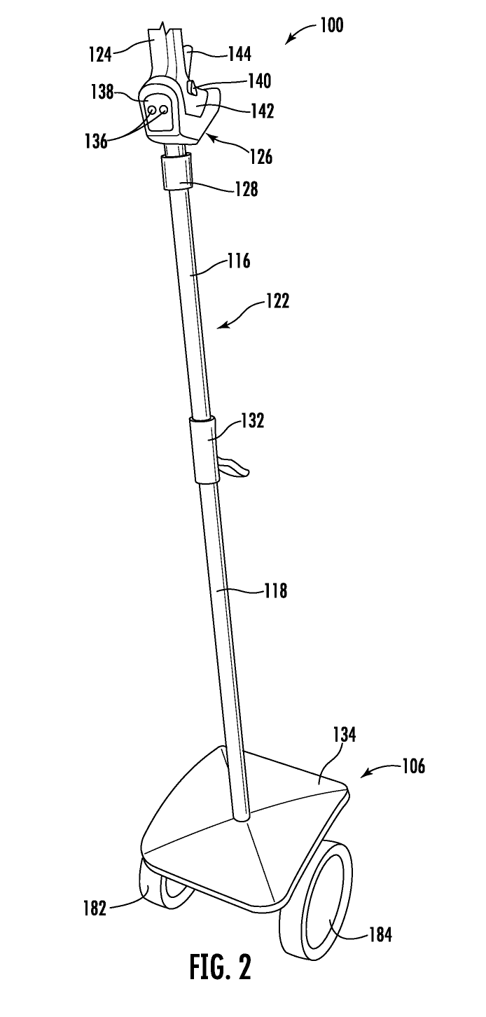

Referring to FIG. 2, the user interface 126 is adjacent to the gripping portion 124 and the first bracket 128. The user interface 126 includes a plurality of compressible buttons 136 (e.g., switches, knobs, toggles) on a front surface 138, a safety button 140 (e.g., switch, knob, toggle) on a side surface 142, and a pivotable trigger/lever 144. The user interface 126 surrounds the tubular frame 122. In alternative embodiments, the user interface 126 may be affixed to the exterior of a portion of the tubular frame 122. In alternative embodiments, the user interface 126 may be may be located adjacent to the electric powerhead 102 or another location along the tubular frame 122. In alternative embodiments, the user interface 126 may include one or more switches, buttons, sliders, levers, dials, touch screens, position sensors, torque sensors, force sensors, and other user input devices and that may located on varying locations on the user interface 126.

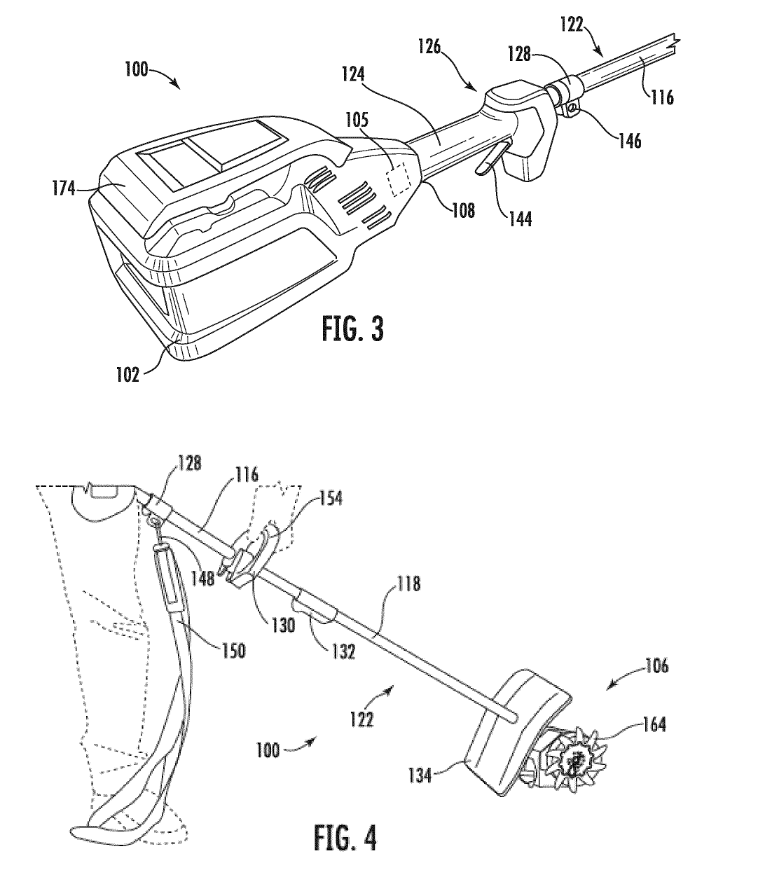

Referring to FIG. 3, the first bracket 128 surrounds the tubular frame 122 and is adjacent to the user interface 126. The first bracket 128 is affixed to the tubular frame 122 and may be made from plastic or composite materials or a combination of both. The first bracket 128 includes a loop 146 extending from the exterior surface of the first bracket 128. The loop 146 extends from a portion of the first bracket 128 proximate to the electric powerhead 102 down to a portion of the first bracket 128 proximate to the cutting assembly 106 (FIG. 1). The loop 146 is configured to receive a hook 148 (FIG. 4) that may be attached to a supportive strap 150 (FIG. 4) to be worn by the user to distribute the weight of the edger 100 to enhance the comfort level for the user while carrying the edger 100. In alternative embodiments, the first bracket 128 may be slidable along a longitudinal axis 152 of the tubular frame 122 or may be removable from the tubular frame 122. In alternative embodiments, varying attachment devices, brackets, hook and eyes, fasteners, may be used in order to attach the supportive strap 150 to the edger 100. For example, the tubular frame 122 may have a screw inserted into the tubular frame 122 having a loop 146 portion at one end of the screw to receive a supportive strap 150.

Referring to FIG. 4, the handle 130 is coupled to the tubular frame 122 in between the first bracket 128 and the second bracket 132. Portions of the handle 130 surround the tubular frame 122 and affix the handle 130 to the tubular frame 122 in a stationary position. The handle 130 includes a second gripping portion 154 that is displaced a distance from the tubular frame 122. To assist maneuvering the edger 100 with ease and stability, the user grasps the first gripping portion 124 with one hand and grasps the second gripping portion 154 with the other hand. In alternative embodiments, the handle 130 may be slidable along the longitudinal axis 152 of the tubular frame 122. For example, to enhance the maneuverability of the edger 100 for the user having shorter arms, the handle 130 may be slid along the tubular frame 122 towards the first bracket, decreasing the distance between the first gripping portion 124 and the second gripping portion 154. Conversely, to enhance the maneuverability of the edger for the user having longer arms, the handle 130 may be slid along the tubular frame 122 towards the second bracket 132, increasing the distance between the first gripping portion 124 and the second gripping portion 154. In alternative embodiments, the handle 130 may have a pivot point allowing a portion of the handle to pivot/fold down into a storage position and be extended into an operating position.

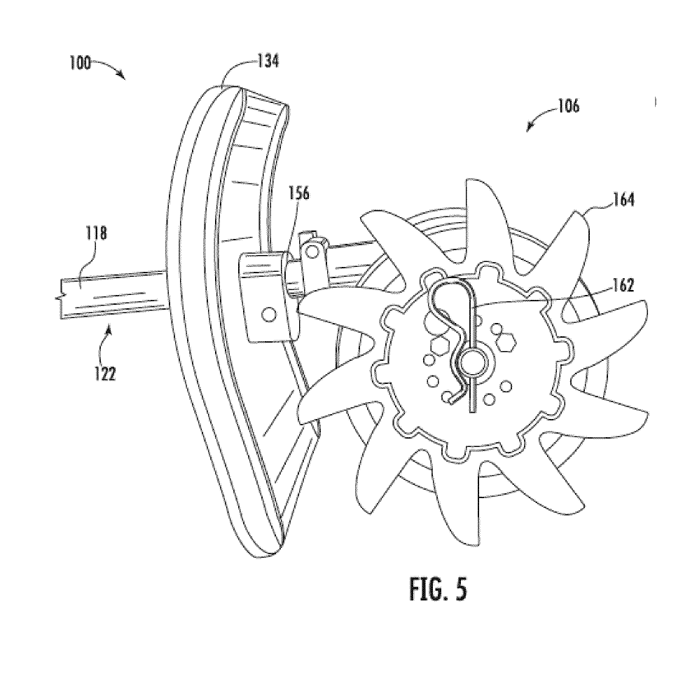

Referring to FIGS. 5-6, the shield 134 includes an opening 156 that is configured to receive a portion of the tubular frame 122. The shield 134 prevents grass clippings, soil and other debris and granular matter from projecting up and hitting the user. The shield 134 is substantially rectangular in shape having a slight arc extending from the front portion to the rear portion of the edger 100. In alternative embodiments the shield may be in various sizes and configurations, e.g., circular, polygonal, oval, etc., or may not have an arcuate portion.

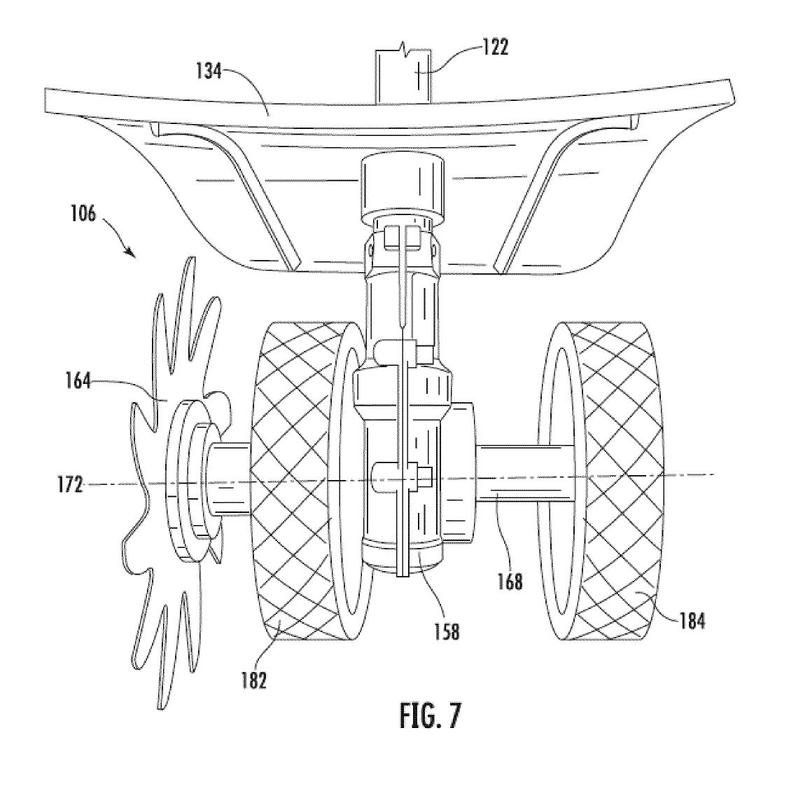

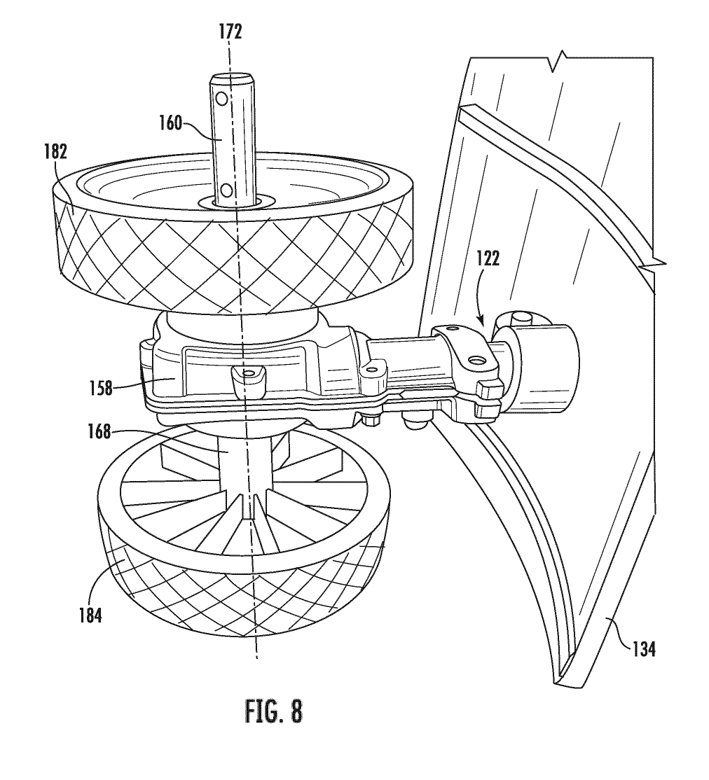

Referring to FIGS. 7-8, an output shaft (not shown) extends from the electric powerhead 102 towards the cutting assembly 106 and is encapsulated in the tubular frame 122. The output shaft rotates between 6700-7600 revolutions per minute (RPM) when the battery 104 is fully charged. The cutting assembly 106 includes a worm drive 158, drive shaft 160, a first guide wheel 182, a second guide wheel 184, a blade 164, a fastener 162 (FIG. 6) and a rod 168. The output shaft is configured to be received in the worm drive 158. Mechanical power is being provided down the tubular frame 122 to the worm drive 158. The blade 164 is driven by the drive shaft 160 that is coupled to the worm drive 158. The worm drive 158 causes the drive shaft 160 to rotate the blade 164 between 150-175 RPM, allowing portions of the blade 164 to contact the ground multiple times, taking smaller amounts of dirt out at a time. Accordingly, the gear ratio of the worm drive 158 is approximately 44:1. As such, the worm drive 158 reduces the speed of the output shaft (e.g., rotating at approximately 7580 RPM) by approximately 44:1 to accomplish the slower rotational speed of the blade 164 (e.g., rotating at approximately 172 RPM). In other embodiments, the gear ratio of the worm drive 158 can be more or less than 44:1. The gear ratio of the worm drive 158 requires less power from the motor 105 to operate the blade 164 (e.g., operate the blade 164 to cut through ground or grass). In this way, the gear ration of the worm drive 158 allows the motor 105 to operate more efficiently in combination with the blade 164 of the edger 100. The blade 164 rotates in the forward direction of travel of the edger 100 about a lateral axis 172. The edger 100 may be moved back and forth in an operative state while the blade 164 forms an edge/trench in the ground and the blade 164 continues to rotate in the forward direction of travel. The rotation of the blade 164 does not change directions at any time during operation. The fastener 162 is inserted in a pin hole 170 and extends the entire diameter of the drive shaft 160 to secure the blade 164 and the first guide wheel 182 on the drive shaft 160. The fastener 162 may be a cotter pin, a bolt and screw arrangement, etc., or any varying other fasteners that may secure the blade 164 and one of the guide wheels 182, 184 to the drive shaft 160. The first and second guide wheels 182, 184 are freely rotating wheels about the lateral axis 172. The first guide wheel 182 includes an opening configured to receive the drive shaft 160 and is adjacent to one side of the worm drive 158. The first guide wheel 182 rotates freely about the drive shaft 160 around the lateral axis 172. The second guide wheel 182 includes an opening configured to receive the rod 168 extending from the opposite side of the worm drive 158. The rod 168 is secured in the opening of the second guide wheel 184 with an adhesive. In other embodiments, the rod 168 can be otherwise secured. The rod 168 sets the distance between the second guide wheel 184 and the worm drive 158. In some embodiments, the length of the rod 168 can be adjusted for different uses. The rod 168 and the second guide wheel 184 rotate freely about the lateral axis 172. The first guide wheel 182 and the second guide wheel 184 provide stability to operate the edger 100. The first guide wheel 182 may also assist the user with aligning the blade 164 to form the desired path of the edger/trench. The first guide wheel 182 is located 180 degrees from the second guide wheel 184. The drive shaft 160 and the rod 168 are located 180 degrees from each other. In alternative embodiments, the rod 168 may be welded or secured to the second guide wheel 182 using varying attaching techniques.

Referring to FIG. 9, the electric powerhead 102 also includes a housing 174, a battery receptacle 120 and an output shaft (not shown) extending from the housing 174 of the electric powerhead 102 to the cuttingly assembly 106 (FIG. 1). The electric motor 105 is positioned within the housing 174 or supported by a cradle or other support structure located within the housing 174. The electric motor 105 is an 800 watt electric motor. In alternative embodiments, the electric motor 105 may be provided with various power ratings, e.g., 1,500 watts, 2,500 watts, 3,500 watts, etc. The output shaft rotates about an axis of rotation 176 when the electric motor 105 is activated.

Still referring to FIG. 9, the battery receptacle 120 is configured to receive a removable battery 104. The removable battery 104 is able to be attached to and removed from the battery receptacle 120 without the use of tools. In other embodiments, the battery 104 may be attached to the housing 174 in a fixed manner requiring the use of tools to remove the battery 104 from the housing 174. The battery receptacle 120 and the battery 104 include contacts that are configured to engage or connect with each other to complete an electrical circuit when the battery 104 is properly inserted into the battery receptacle 120. The connection between the battery receptacle 120 and the battery 104 allows the battery 104 to provide electricity to the electric motor and other electrical components. The battery 104 includes multiple cylindrical lithium ion cells that extend along a longitudinal axis. In other embodiments, the cells may be of varying shapes, e.g., prismatic cells, or may have different battery chemistries, e.g., nickel-cadmium, lead-acid, nickel metal hydride, nickel-zinc, etc. The battery 104 may be provided in various configurations resulting in varying energy capacities and voltage ratings. For example, in alternative embodiments, the battery 104 may provide between 150 and 500 watt hours of energy at a voltage rating of 82 volts. In other embodiments, more than one battery 104 and battery receptacle 120 may be provided in order to increase the amount of electrical energy available for use by the electric powerhead 102.

Referring to FIG. 10, the battery receptacle 120 is positioned in the housing 174 so that the battery 104 is inserted into the battery receptacle 120 at a straight axis of insertion 178. The axis of insertion 178 is positioned at an angle relative to the axis of rotation 176. For example, as shown in FIG. 10, the axis of insertion 178 is perpendicular to the axis of rotation 176. Referring to FIG. 9, the battery receptacle 120 includes a stop surface that is configured to contact a face or other surface of the battery 104 when the battery 104 is properly inserted into the battery receptacle 120. In some embodiments, the axis of insertion 178 is orthogonal to the stop surface of the battery receptacle 120. In some embodiments, when the battery 104 is inserted into the battery receptacle 120, the longitudinal axes of the battery cells in the battery 104 are parallel to the axis of insertion 178.

Referring to FIGS. 9-10, the battery 104 and battery receptacle 120 are positioned one side of the housing 174 near the top of the housing. In alternative embodiments, the battery 104 and the battery receptacle 120 may be positioned on the top of the housing 174 or may be positioned proximate the rear of the housing 174. The battery 104 is readily accessible to a user on the top, rear, or either side portions of the housing 174 so that the user can insert or remove the battery 104 without removing the electric powerhead 102 from a mounted position on the edger 100.

In some embodiments, the battery 104 and the battery receptacle 120 include mechanical aligning features to ensure proper alignment between the battery 104 and the battery receptacle 120 and/or to guide the battery 104 into the battery receptacle 120. For example, the battery 104 includes a protrusion and the battery receptacle 120 includes a corresponding slot to receive the protrusion of the battery 104. The battery 104 may be removed from the housing 174 and attached to a charging station (not shown) to charge the battery 104. The charging station connects to a source of electricity, e.g., a power grid, generator, etc. In alternative embodiments, the battery 104 or the housing 174 may include an outlet or port to connect to a charging device. The charging device includes a plug and a cord to connect the outlet to a source of electricity.

The electric powerhead 102 also includes a controller or processing circuit (not shown) for controlling operation of electrical components of the powerhead 102. In some embodiments, the controller also controls operation of and/or communicates with electrical components coupled to the electric powerhead 102, e.g., electrically coupled by wires or wirelessly coupled. The controller can include a processor and memory device. The processor can be implemented as a general purpose processor, an application specific integrated circuit (ASIC), one or more field programmable gate arrays (FPGAs), a group of processing components, or other suitable electronic processing components. The memory device, e.g., memory, memory unit, storage device, etc., is one or more device, e.g., RAM, ROM, flash memory, hard disk storage, etc., for storing data and/or computer code for completing or facilitating the various process, layers and modules described in the present application. The memory device may be or include volatile memory or non-volatile memory. The memory device may include database components, object code components, script components, or any other type of information structure for supporting various activities and information structures described in the present application. In the exemplary embodiment, the memory device is communicably connected to the processor via the processing circuit and includes a computer code for executing, e.g., by processing circuit and/or processor, one or more processes. The controller may be positioned in and/or attached to the housing 174.

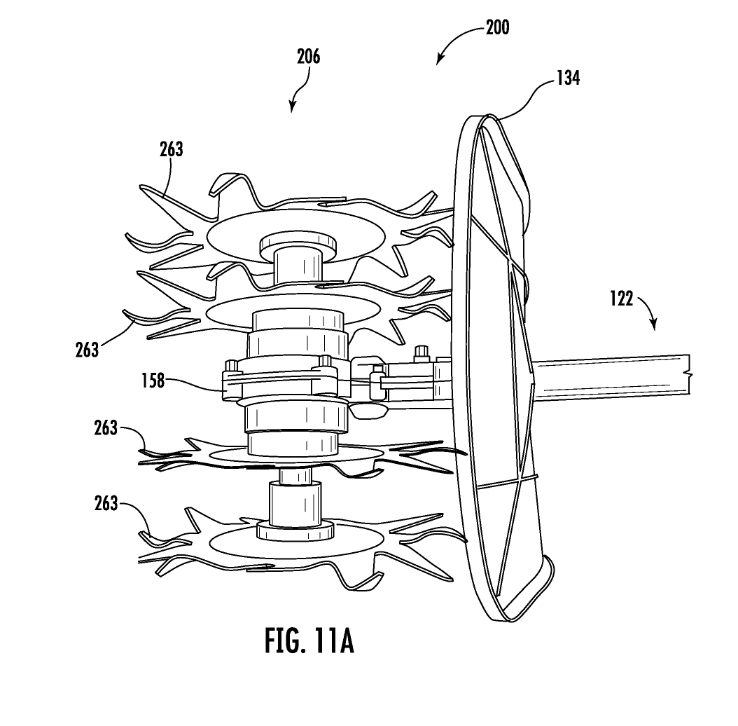

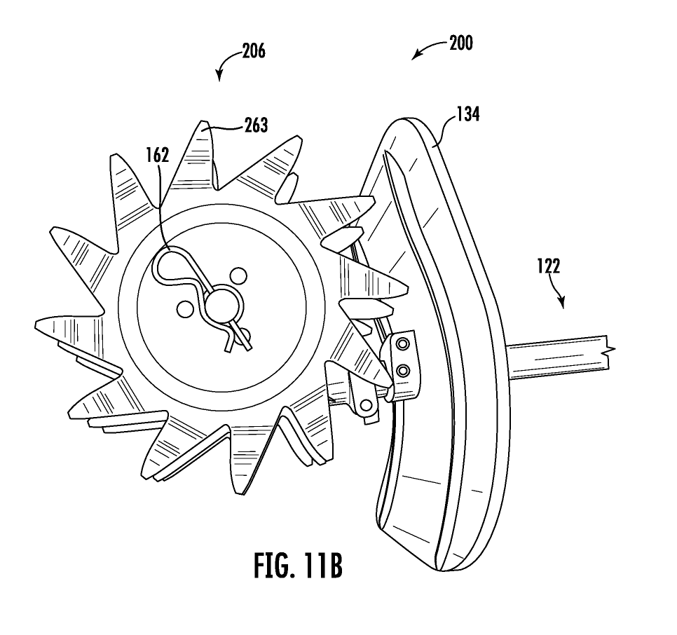

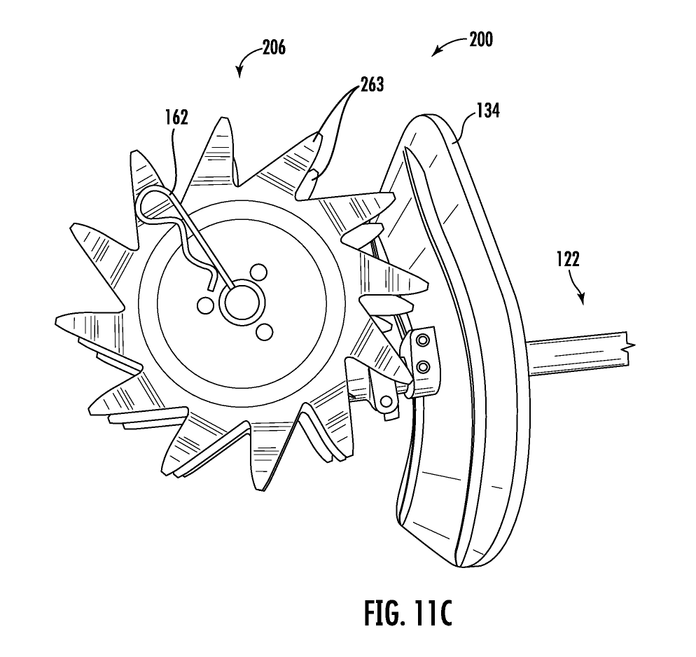

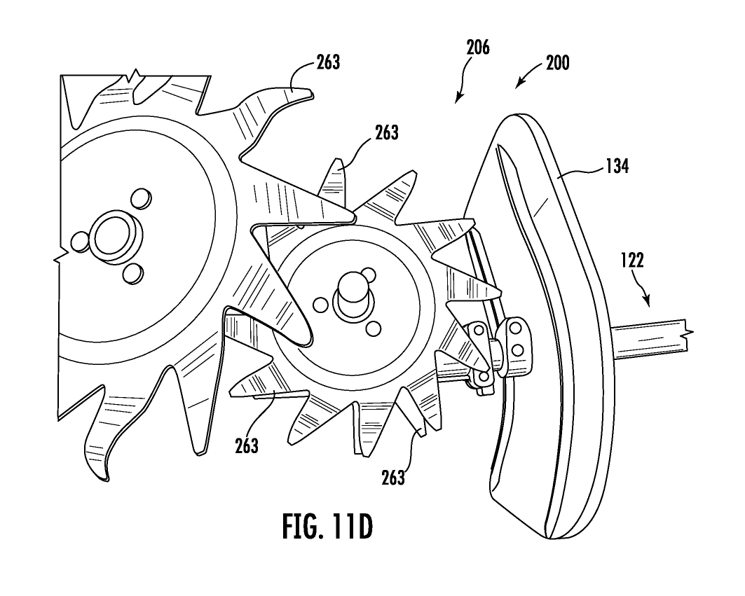

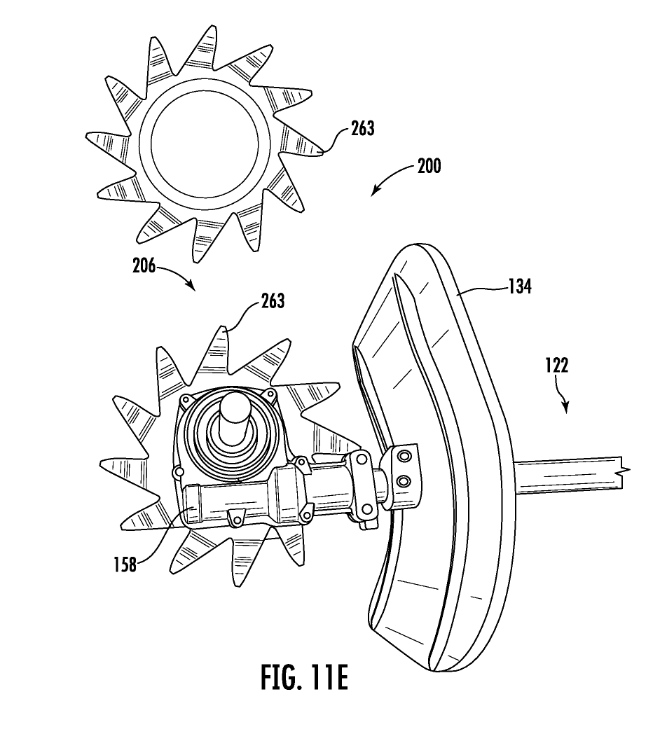

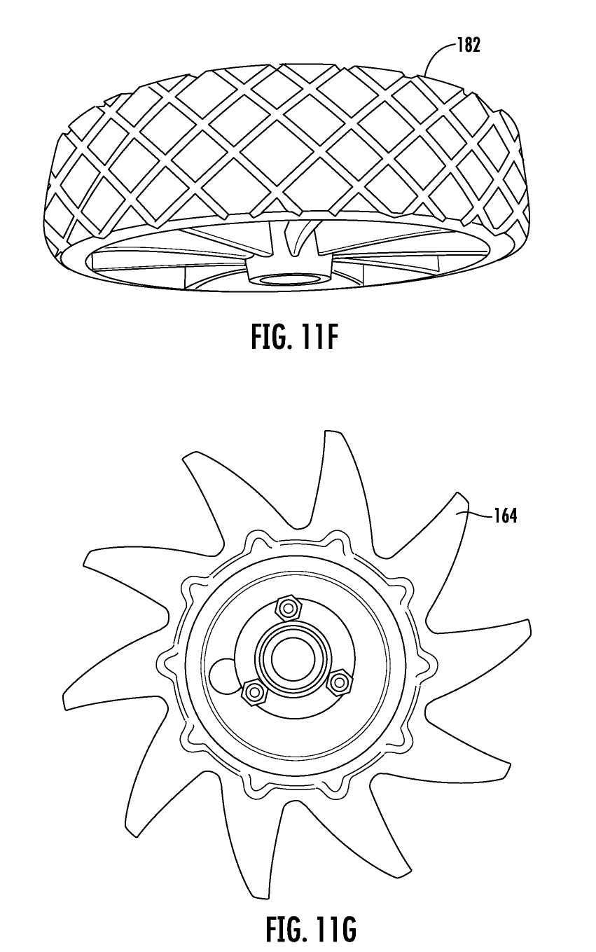

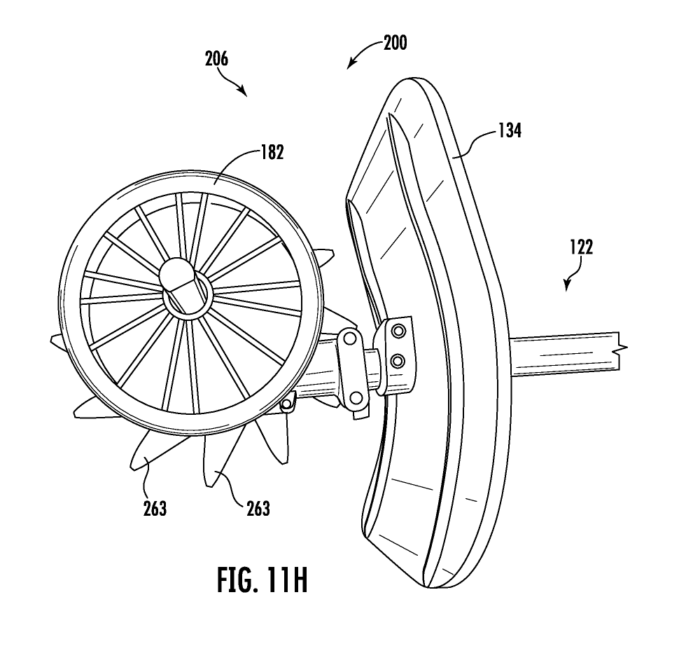

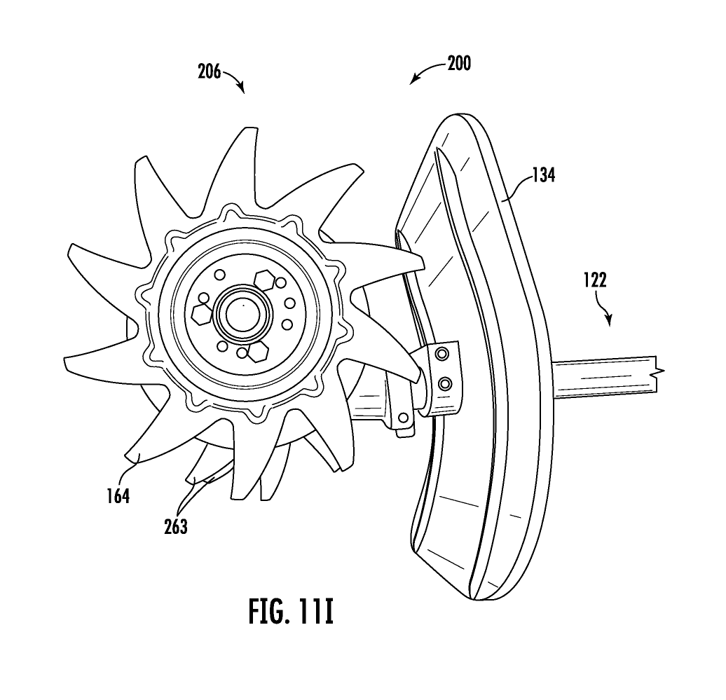

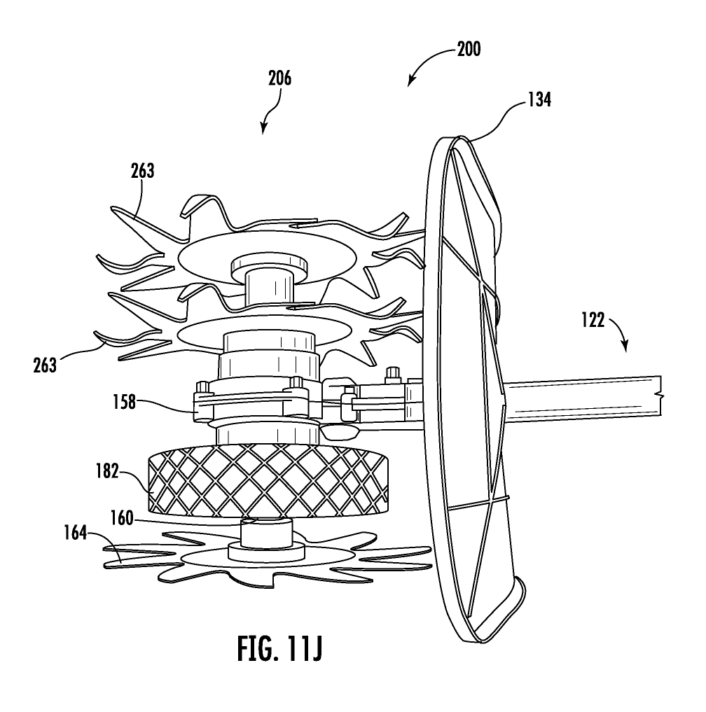

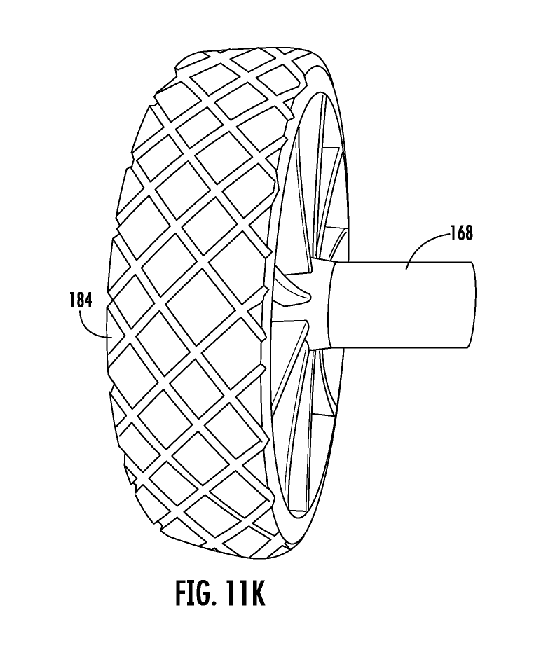

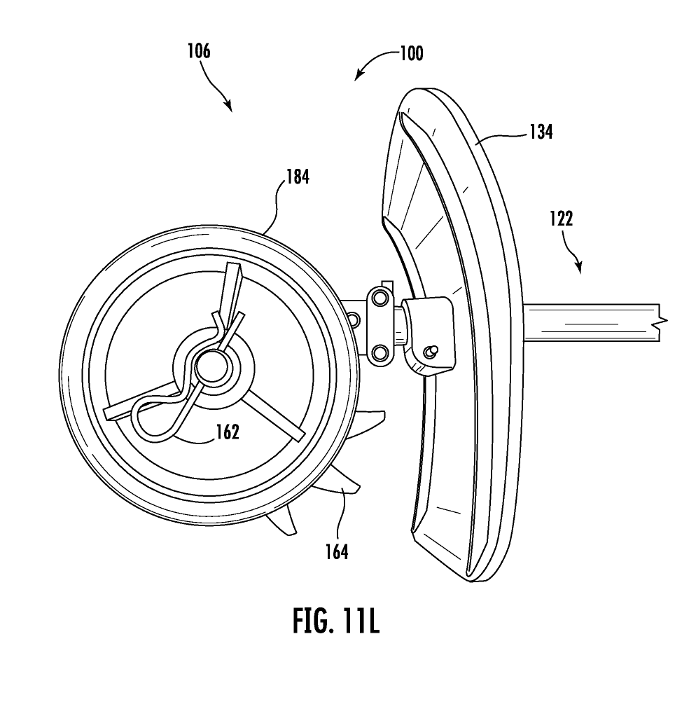

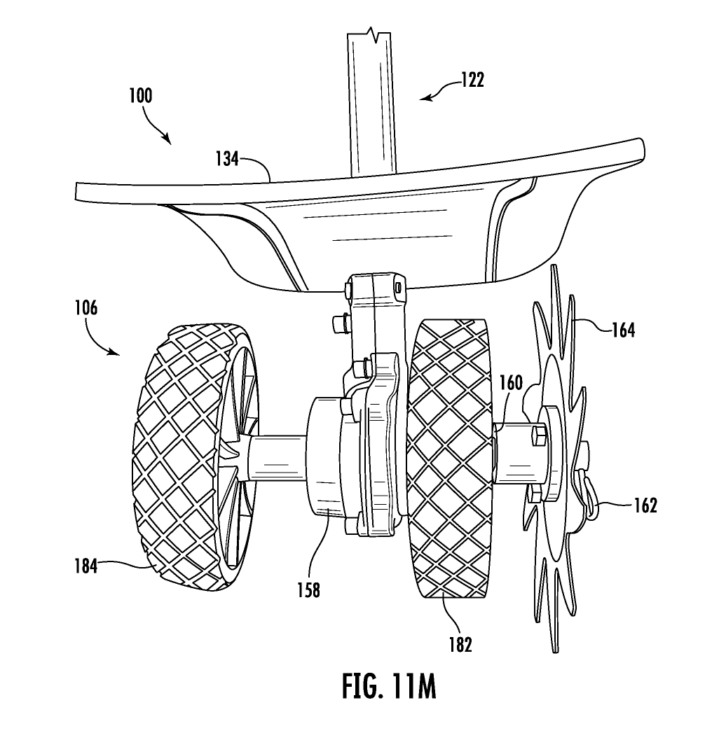

Referring to FIGS. 11A-11M, a method of exchanging a cutting assembly (e.g., a cultivator cutting assembly 206) from a different piece of outdoor power equipment (e.g., cultivator 200) with the edger cutting assembly 106 is shown, according to one embodiment.

Referring to FIG. 11A, a cultivator 200 is shown, according to one embodiment. The cultivator 200 includes an electric powerhead 102 (e.g., the same powerhead used with the edger 100 shown in FIG. 1) and a cultivator cutting assembly 206. The electric powerhead 102 includes an electric motor 105 (FIG. 1) and a battery 104 (FIG. 9) that powers the electric motor 105. An output shaft extends from the electric powerhead 102 towards the cultivator cutting assembly 206 and is encapsulated in the tubular frame 122. The output shaft rotates between 6700-7600 RPM. In some embodiments, the output shaft rotates at 7580 RPM. The cutting assembly 206 includes the same worm drive 158 as the edger 100 described above. The cutting assembly 206 also includes multiple cultivator blades 263. The cultivator blades 263 have varyingly angled tines, whereas the tines on the blade 164 of the edger 100 are flat in profile. The output shaft is configured to be received in the worm drive 158. Mechanical power is provided down the tubular frame 122 to the worm drive 158. The blades 263 are driven by the drive shaft 160 (FIG. 11J) that is coupled to the worm drive 158 to perform a cultivating task. The blades 263 rotate in the forward direction of travel of the cultivator 200. The worm drive 158 causes the drive shaft 160 to rotate the blades 263 between 150-175 RPM. In some embodiments, the blades 263 rotate at 172 RPM. Accordingly, as described above with regard to the edger 100, the gear ratio of the worm drive 158 is approximately 44:1. The worm drive 158 reduces the speed of the output shaft (e.g., rotating at approximately 7580 RPM) by approximately 44:1 to accomplish the relatively slower rotational speed of the blades 263 (e.g., rotating at approximately 172 RPM). In other embodiments, the gear ratio of the worm drive 158 can be more or less than 44:1.

Referring to FIG. 11B, the fastener 162 is inserted in a pin hole and extends the entire diameter of the drive shaft 160 to secure the blades 263 on the drive shaft 160 (FIG. 11J). Referring to FIG. 11C, the fastener 162 is removed from the pin hole. Removing the fastener 162 allows one blade 263 to be removed (FIG. 11D) and a second blade 263 to be removed (FIG. 11E) from the drive shaft.

Referring to FIGS. 11F and 11G, the first guide wheel 182 and the blade 164 of the edger 100 are shown, according to an exemplary embodiment. Referring to FIGS. 11H-11M, first, the first guide wheel 182 is assembled with the cutting assembly onto the drive shaft, and then, the blade 164 is inserted on top of the first guide wheel 182 and secured into place using the fastener 162. FIG. 11J shows the cutting assembly after the first guide wheel 182 and blade 164 are assembled onto the drive shaft 160. Next, the two remaining cultivator blades 263 are removed from the drive shaft 160 and the second guide wheel 184 with rod 168 (FIG. 11K) are secured onto drive shaft 160, now forming the cutting assembly 106 for the edger 100 shown in FIGS. 11L and 11M.

Referring to the figures generally, the worm drive 158 used with the edger 100 described above is the same worm drive 158 used with the cultivator 200. Using the large reduction gear ratio (e.g., 44:1) of the worm drive 158 that is used in a cultivator 200, the occurrence of motor overload conditions is less likely than with a typical edger used with a high-speed motor. The large reduction gear ratio allows the same powerhead (e.g., electric powerhead 102), rotating at the same speed, to be used across a variety of different attachments, including the edger 100 described above. Allowing the blade 164 of the edger 100 to rotate slowly allows the motor 105 to operate continuously without interruption as the blade 164 cuts through grass.

In addition, the blade 164 is used as part of the edger cutting assembly 106. The blade 164 used with the edger 100 is a singular blade and has flattened tines as compared to the blades 263 used on the cultivator cutting assembly 206, which include varyingly angled tines. Furthermore, the edger 100 described above uses first and second guide wheels 182, 184 to stabilize the edger 100 as an operator is using the unit. Because of the different purpose of the edger 100 as compared to the cultivator 200, the guide wheels 182, 184 act to stabilize the edger 100 while the operator maintains a straight cutting line with the blade 164.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

What is claimed is:

1. A handheld edger comprising:
an electric powerhead coupled to a mounting location, the electric powerhead comprising:
a motor having an output shaft rotating at a first speed about an output shaft axis;
a battery configured to power the motor;
a member extending from the mounting location, the member including an upper portion and a lower portion, the lower portion configured to be removable and replaceable to exchange one or more attachments;
a cutting assembly coupled to the member comprising:
a drive shaft;
a blade coupled to and driven by the drive shaft; and
a worm drive coupled to the output shaft of the motor and the drive shaft, the worm drive configured to cause the drive shaft to rotate the blade at a second speed;
wherein a gear ratio of the worm drive is larger than 40:1.

2. The handheld edger of claim 1, wherein the first speed comprises a range of 7000 revolutions per minute (RPM) to 7600 RPM and the second speed comprises a range of 150 RPM to 175 RPM.

3. The handheld edger of claim 2, wherein the motor is an 800 Watt electric motor.

4. The handheld edger of claim 1, wherein the motor is an 800 Watt electric motor.

5. The handheld edger of claim 1, wherein the blade includes one or more tines having a flat profile.

6. The handheld edger of claim 1, further comprising a first guide wheel coupled to the drive shaft proximate a first side of the worm drive and configured to freely rotate about a wheel axis.

7. The handheld edger of claim 6, further comprising a second guide wheel coupled to a rod extending from a second side of the worm drive and configured to freely rotate about the wheel axis.

8. The handheld edger of claim 1, further comprising a fastener inserted into a hole on the drive shaft and configured to maintain the blade on the drive shaft.

9. The handheld edger of claim 1, wherein the electric powerhead further comprises a housing and a battery receptacle formed in the housing;
wherein the battery is configured to be inserted into the battery receptacle and removable and replaceable without the use of tools.

10. The handheld edger of claim 9, wherein the battery is inserted into the battery receptacle along an axis of insertion perpendicular to the output shaft axis.

11. The handheld edger of claim 1, wherein the gear ratio of the worm drive is larger than 43:1 and less than 45:1.

12. The handheld edger of claim 1, wherein the member further comprises:
a user interface including one or more user input devices;
a gripping portion positioned proximate the user interface;
a handle positioned on the upper portion; and
a shield coupled to the lower portion of the member and configured to prevent debris from projecting upward.

13. The handheld edger of claim 12, wherein the handle is configured to slidable along the member between a first position proximate the gripping portion and a second position further from the gripping portion than the first position.

14. A cutting assembly for use with a handheld edger comprising:
a drive shaft;
a blade coupled to and driven by the drive shaft; and
a worm drive coupled to an output shaft of a motor and the drive shaft, the worm drive configured to cause the drive shaft to rotate the blade at a cutting speed;
wherein a gear ratio of the worm drive is larger than 40:1.

15. The cutting assembly of claim 14, further comprising:
a first guide wheel coupled to the drive shaft proximate a first side of the worm drive and configured to freely rotate about a wheel axis.

16. The cutting assembly of claim 15, further comprising
a second guide wheel coupled to a rod extending from a second side of the worm drive and configured to freely rotate about the wheel axis.

17. The cutting assembly of claim 16, wherein a length of the rod is customizable to a plurality of lengths.

18. The cutting assembly of claim 14, wherein the cutting speed comprises a range of 150 RPM to 175 RPM.

19. The cutting assembly of claim 14, wherein the cutting speed is 172 RPM.

20. The cutting assembly of claim 14, wherein the blade includes one or more tines having a flat profile.
